(19) United States
(12) Patent Application Publication
(10) Pub. No.: US 2018/0036746 A1
(43) Pub. Date: Feb. 8, 2018

(54) Filter and Cyclone Filter System

(71) Applicant: MANN+HUMMEL GMBH, Ludwigsburg (DE)

(72) Inventors: Chowalloor Rapheal Antomon, Bangalore (IN); Suresh Aragbatagangapa Eswarapa (A.G.E.), Bangalore (IN); Anil Kumar HC, Bangalore (IN)

(21) Appl. No.: 15/671,534

(22) Filed: Aug. 8, 2017

(30) Foreign Application Priority Data
Aug. 8, 2016 (DE) 10 2016 009 535.0

(51) Int. Cl. B04C 9/00; B04C 5/04; B04C 5/187; B01D 50/00; B01D 46/00; B01D 46/48; B04C 5/103; B01D 45/16

(52) U.S. Cl. CPC B04C 9/00; B04C 5/103; B04C 5/04; B01D 45/16; B01D 50/002; B01D 46/0045; B01D 46/48; B04C 5/187; B04C 2009/004; B01D 2279/60; B01D 2273/30; B01D 2265/06; F02M 35/0223

(57) ABSTRACT

The invention relates to a filter (28) for removing particulate matter from a gaseous fluid (12) having a filter element (30) with a filter media (32) which is arranged in a ring-shaped fashion around the longitudinal axis (34) thereof and a pre-separator sleeve (40) which seats on the filter element (30) and which has several perforations (52). On an outside surface (42) of the pre-separator sleeve (40), there is arranged at least one guide vane (44) which extends radially outwards from the pre-separator sleeve (40). The guide vane (44) is wound around the pre-separator sleeve (40) in a helical fashion to thereby further increase the separating efficiency of the pre-separator sleeve (40). The invention further relates to a cyclone filter system with an aforesaid filter (28).

### TECHNICAL FIELD

The invention relates to a filter and a cyclone filter system with such a filter for removing particulate matter from a gaseous fluid such as, for instance, the intake air of a combustion engine or the interior ventilation of a cabin, in particular a motor vehicle. The filter comprises a filter element having a filter media which is arranged in a ring-shaped fashion around the longitudinal axis of the filter element and a pre-separator sleeve which seats on the filter element and which has several perforations or flow openings for the gaseous fluid. The pre-separator sleeve has at least one guide vane for the gaseous fluid which extends radially outwards from the pre-separator sleeve.

### BACKGROUND

A cyclone filter system comprising a filter housing and an aforementioned filter is known from US 2015/0068169 A1. The pre-separator sleeve of the filter is provided with multiple guide vanes which are arranged in a strictly circular fashion around the pre-separator sleeve. Said guide vanes are designed to direct the gaseous fluid in a spiral or cyclone-like motion around the filter for a pre-separation of particles contained in the gaseous fluid before entering the filter media. The gaseous fluid is preferably introduced radially or tangentially to the filter and strikes the guide vanes arranged on the outer periphery of the pre-separator, whereby the gas flow preferably undergoes deflection and acceleration, which leads to the separation of coarse contaminants such as dirt and dust particles as well as water droplets from the gaseous fluid. The contaminants are thrown particularly tangentially outward and can optionally be discharged from the housing via a discharge opening. After passing through the pre-separator, the gas flow is fed to the filter element that seat is within the cylindrical pre-separator.

### SUMMARY OF THE INVENTION

The object of the invention is to provide a filter as well as a cyclone filter system which shows a further enhanced pre-separation capability.

According to the invention, the filter for removing particulate matter from a gaseous fluid comprises a filter element with a filter media which is arranged in a ring-shaped fashion around the longitudinal axis thereof. The filter has a pre-separator sleeve which seats on the filter element and which has several flow openings or perforations, wherein, on an outside surface of the pre-separator sleeve, there is arranged at least one guide vane which extends radially outwards from the pre-separator sleeve and which is wound around the pre-separator sleeve in a helical fashion. Due to the helical guide vane, the gaseous fluid to be filtered can be more effectively guided as a swirling or helical flow or stream around and along the filter in the longitudinal direction thereof such that particulate matter or water droplets contained in the gaseous fluid are more efficiently separated from the gaseous fluid prior to entry of the filter. This results in a considerable improvement in filter life. Further, the filter according to the invention does not require an increased mounting space and can be readily used in filter housings of existing cyclone filter systems. The pre-separator sleeve may contact the filter media of the filter element in a radial direction or may be spaced from the filter media in a radial direction. The pre-separator sleeve, preferably, has an axial length that corresponds to or essentially corresponds to the length of the filter element, particularly a shorter length. Preferably, the helical guide vane shows no interruptions such as gaps, holes, dents, recesses or the like.

According to a preferred embodiment of the invention, the pre-separator sleeve has a non-perforated first end portion. The said non-perforated end portion thus has no flow openings located in the wall of the sleeve and can serve as a reception zone or baffle for the gaseous fluid that is fed to the filter during use to prevent the fluid from a direct entry into the filter prior to a cyclonic pre-separation of contaminants in the gaseous fluid. The gaseous fluid stream can thereby be more effectively forced in a spiral direction around the filter to form a cyclone flow under guidance of the sleeve's helical vane.

During operation of the filter, a circulating flow of the gaseous fluid in a circumferential direction around the filter, in other words a continuous looping of the gaseous fluid, in particular in the region of the abovementioned non-perforated end portion of the pre-separator sleeve, needs to be prevented for an efficacious pre-separation of coarse contaminants prior to filtration of the gaseous fluid. The non-perforated end portion of the pre-separator sleeve may, therefore, have a flow locking means which serves to prevent such an unwanted recurrent travel of the gaseous fluid in a tight circle around the filter. The flow-locking means, according to a preferred embodiment of the invention, is formed by a branch of the guide vane in the non-perforated end portion of the sleeve. The branch preferably has an arcuate form and runs essentially in an axial direction to block an unwanted circling flow of the fluid.

According to a preferred embodiment of the invention, the helical guide vane extends over a major portion of the total length of the pre-separator sleeve. Thereby, the overall length of the filter can be effectively used for a cyclonic pre-separation of contaminants from the gaseous fluid.

The hollow pre-separation sleeve can be made of metal or sheet metal; optionally, a plastic material, particularly thermoplastic material such as PE used in the injection-molding process, can also be considered. This allows for a cost-efficient manufacture of the pre-separation sleeve with minimum wall thickness to ensure a maximum pre-separation gap between the filter and a filter housing in a radial direction. The helical vane is advantageously directly molded on the pre-separation sleeve.

The pre-separation sleeve, according to the invention, may have a reinforcement ring. This allows for a very low wall thickness of the pre-separation sleeve. Apart from the cost benefits associated therewith, the reinforcement ring improves the stability of the filter element, even under challenging working environments. The reinforcement ring is advantageously directly molded on the pre-separation sleeve such that no additional manufacturing steps are needed. Also, said reinforcement ring allows use of an available mounting or installation space for the filter within a filter housing for the filter element.

According to a preferred embodiment of the invention, the helical guide vane, in the longitudinal direction, extends to or essentially extends to a reinforcement ring of the pre-separator sleeve. The reinforcement ring may extend in a radial direction away from the pre separator sleeve at an end portion which, in an axial direction, is located opposite of the on-perforated end portion of the pre-separation sleeve.

According to a further embodiment of the invention, the helical vane has a base section which is connected to the pre-separator sleeve and which extends away from the pre-separator sleeve in a radial direction and an angled end section which is joined to the base section. This embodiment allows for a further acceleration of flow of the gaseous fluid and thus an improved separative capacity of the pre-separator sleeve.

According to a further preferred embodiment of the invention, the flow openings or perforations of the pre-separator sleeve can be covered by the helical vane in a radial direction such that the incoming fluid gas stream to be filtered can be forced to make a full turn in an axial direction before entering the filter. Thereby, the pre-separating efficiency of the filter can be even further increased. The aforesaid end portion of the guide vane is preferably arranged parallel or essentially parallel to the outer surface of the pre-separator sleeve.

The helical vane preferably has a radial extension which is at least 10% of the external diameter of the pre-separator sleeve. This reduces an unwanted straight axial overflow of the guide vane by the gaseous fluid.

The cyclone filter system according to the invention serves for removing contaminants, in particular particulate matter, from a gaseous fluid. The cyclone filter system comprises a filter housing having a fluid inlet port and a fluid outlet port and a filter as described above which is positioned inside the filter housing.

According to a preferred embodiment of the filter system, the fluid inlet port is arranged on a side wall of the filter housing to allow for a radial or tangential flow of the gaseous fluid to the filter. In case that the pre-separation sleeve of the filter features the aforementioned non-perforated end portion, the filter is advantageously positioned inside the filter housing such that the said end portion of the pre-separation sleeve is located next to the inlet port of the filter housing. The inlet port in this case thus leads to the non-perforated end portion of the pre-separation sleeve.

The outlet port of the filter housing is preferably arranged on an end face of the housing which is preferably adjacent to the fluid inlet port thereof. A flow length of the gaseous fluid within the filter housing can thereby be maximized.

According to a further embodiment of the cyclone filter system, the filter housing forms a dirt chamber for particulate matter separated from the gaseous fluid by the pre-separator sleeve which is arranged in the axial direction at an opposite end of the fluid outlet of the housing and which, preferably, extends in a radial direction thereof. The contaminants separated from the gaseous fluid can be thus stored to prevent an unwanted reentry of the contaminants into the gaseous fluid stream.

### BRIEF DESCRIPTION OF THE DRAWINGS

Various other features and attendant advantages of the present invention will be more fully appreciated as the same becomes better understood when considered in conjunction with the accompanying drawings, in which like reference numerals characterize the same or similar parts throughout the several views, and wherein:

FIG. 1 is a sectional view of a cyclone filter system with a filter configured in accordance with the present invention;

FIG. 2 is a perspective view of the filter of the filter system of FIG. 1;

FIG. 3 is a different perspective view of the filter of FIG. 2;

FIG. 4 is a front elevation of a pre-separator sleeve of the filter of FIG. 2

FIG. 5 is a perspective view of an alternative embodiment of a pre-separator sleeve for the filter of FIG. 1;

FIG. 6 is a perspective view of a further embodiment of a filter; and

FIG. 7 is a sectional view of a further embodiment of a filter system with the filter of FIG. 6.

### DESCRIPTION OF THE DISCLOSURE

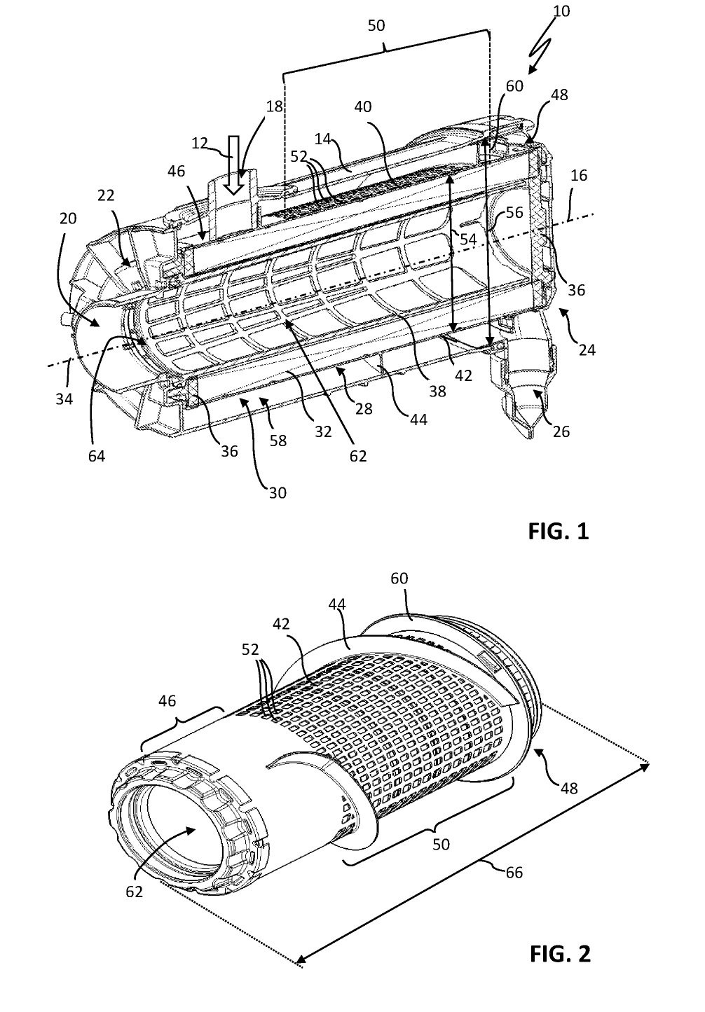

FIG. 1 shows a cyclone filter system 10 for cleaning a gaseous fluid 12, i.e. the combustion air that is fed to the cylinders of a combustion engine (not shown). The filter system 10 has a filter housing 14 embodied as a cyclone that is hollow and cylindrical. The filter housing 14 has a longitudinal axis 16, a lateral inlet port 18 over which the uncleaned gaseous fluid 12 flows radially or tangentially into the housing 14 and an axial fluid outlet port 20 located centrally at a one end 22 of the housing 14. The filter housing 14, preferably at its other end 24, forms a dirt chamber 26 for particulate matter or water droplets separated from the gaseous fluid 12 which can, in particular extend in a radial direction thereof.

There is a filter 28 arranged inside the filter housing 14. The filter 28 comprises a hollow cylindrical filter element 30 with a filter medium 32 arranged in a circular fashion around the longitudinal axis 34 of the filter element 30. The filter medium 32 may be starpleated in order to maximize the effective surface area thereof. Also, the filter medium 32 may be disposed between two end plates 36. There may be provided a grid-shaped support tube 38 for a radial support of the filter medium 32. The filter medium 32 is flowed through radially from the outside to the inside by the gaseous fluid 12 to be filtered.

The filter element 30 is seated within a hollow cylindrical pre-separator sleeve 40 which, on its outside surface 42 has at least one guide vane 44 for the gaseous fluid 12 which extends from the pre-separator sleeve 40 in a radial outward direction.

The pre-separator sleeve 40 extends from a first end portion 46 to a second end portion 48 thereof. The first end portion 46 serves as a baffle for the gaseous fluid. The first end portion 46 is non-perforated. The non-perforated first end portion 46 is located right next to the fluid inlet port 18 of the filter housing 14 such that an inflow of the gaseous fluid 12 is fed right against the said non-perforated end portion 46. Bordering the non-perforated end portion 46 in an axial direction, the pre-separator shows a longitudinal middle portion or segment 50 with a multitude of perforations 52. The perforations 52 allow for a radial entry of the gaseous fluid 12 into the filter 28.

The pre-separator sleeve 40 has a smaller outer diameter 54 than the inner diameter 56 of the filter housing 14, so that an annular space 58 is formed between the wall of the housing 14 and the pre-separator sleeve 40 in which the inflowing, uncleaned gaseous fluid 12 can disperse. The pre-separator sleeve 40 is preferably made of plastic, particularly injection-molded thermoplastic plastic, or metal. The pre-separator sleeve 40 may have at least one stiffening or reinforcement ring 60 which is preferably located at the second end portion 48 located opposite the said non-perforated end portion 46. The at least one reinforcement ring 60 extends in a radial direction away from the pre-separator sleeve 40 and allows for a minimal material thickness of said sleeve.

The gas entering the annular space 58 undergoes swirling supported by the guide vane 44 and undergoes deflection in a radial direction towards the inside 62 of the filter element, whereby coarse contaminants that are being carried along in the gaseous fluid, for example dirt particles or water droplets, are thrown tangentially outward and thus separated from the gaseous fluid 12 flow.

As the gaseous fluid 12 continues to flow, it enters the filter 28 via the perforations 52 provided in the pre-separator sleeve 40. After passing the filter medium 32 of the filter element, the thus filtered gaseous fluid 12 is then discharged axially from the inner space 62 of the filter element 30 via an axial outlet 64 of the filter fluidly connected to the axial outlet port 20 of the filter housing 14. It needs to be noted that there may be provided a further inner annular space between the pre-separator sleeve 40 and the filter medium 32 of the filter element 30 on the raw side of the filter element 32. In other words, the pre-separator sleeve dos not necessarily need to directly contact the filter medium in a radial direction.

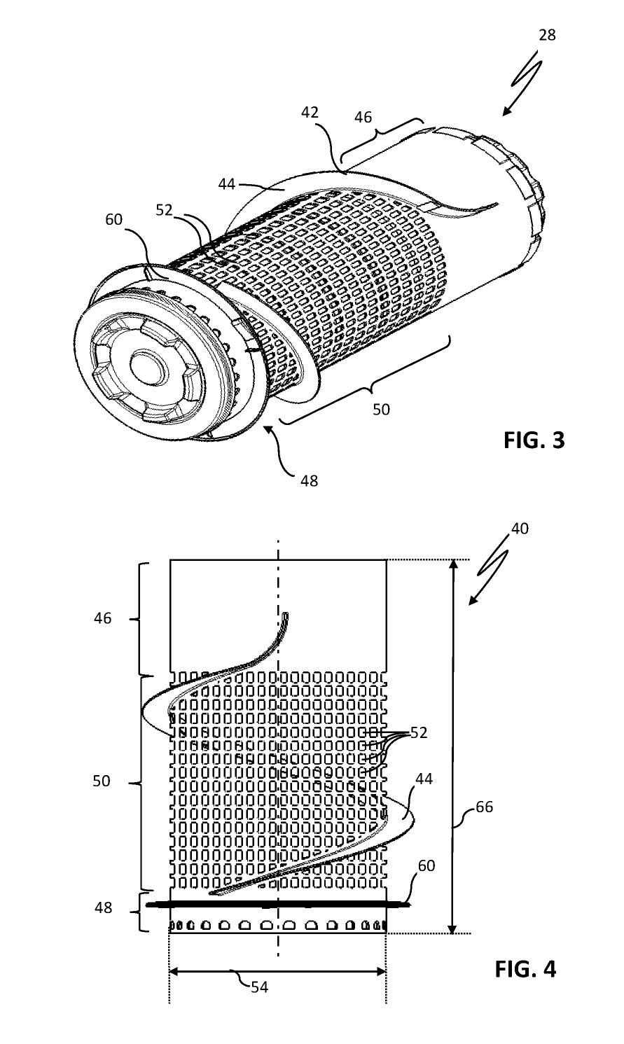

FIGS. 2 and 3 show different perspective representations of the filter 28 from the exemplary embodiment according to FIG. 1. The guide vane 44 of the pre-separator sleeve 40 is wound around the pre-separator sleeve 40 and its longitudinal axis 34 in a helical fashion. The helical guide vane preferably has no interruptions, in particular gaps or recesses. The helical guide vane 44 can extend from the baffle or non-perforated first end portion 46 of the pre-separator sleeve 40 over a major portion of the total length 66 of the pre-separator sleeve 40.

Further, in the present embodiment shown in FIGS. 1 to 3, the helical guide vane 44 forms more than one full turn or winding on the pre-separator sleeve. It is needless to say, that the guide vane 44 may even form two full turns or windings on the pre-separator sleeve, in particular depending on the total length of the sleeve and the expected maximal flow of the gaseous fluid during use of the filter. The helical guide vane 44, in the longitudinal direction, extends to or essentially to the reinforcement ring 60 of the pre-separator sleeve 40 which extends in a radial direction away from the pre-separator sleeve 40.

As can be best seen from the individual depiction of the pre-separator sleeve 40 shown in FIG. 4, the helical guide vane 44 has a radial extension which is at least 10% of the outer diameter 54 of the pre-separator sleeve 40.

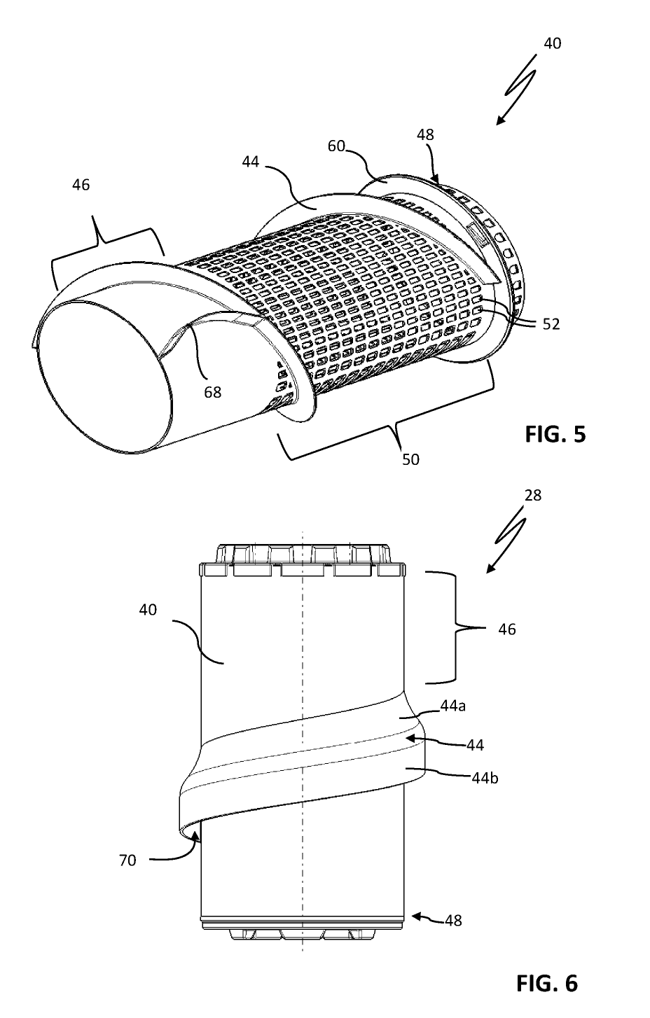

FIG. 5 shows a modified embodiment of a pre-separator sleeve 40 for the filter 28 shown in FIGS. 1 to 3 which is provided with an additional flow locking means 68 for preventing a circulating flow of the gaseous fluid in a circumferential direction of the non-perforated first end portion 46 of the pre-separator sleeve 40. The flow-locking means 68 may be preferably formed by a, in particular arcuate, branch of the helical guide vane 44.

FIG. 6 shows a modified embodiment of the filter 28 with the helical guide vane 28 having a base section 44a extending away from the pre-separator sleeve 40 in a radial direction and an angled end section 44b which is directly joined to the base section 44a. The angled end section 44b extends in an axial direction and is aligned in a parallel or essentially parallel fashion with respect to the outside surface 42 of the pre-separator sleeve 40.

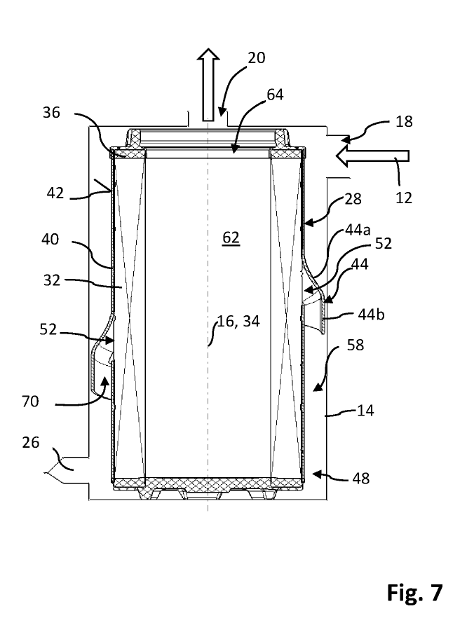

FIG. 7 shows a sectional view of a further cyclone filter system 10 with a housing 14 and the filter 28 of FIG. 6 arranged therein. The flow openings or perforations 52 of the pre-separator sleeve 40 are arranged one behind the other in a helical fashion which corresponds to the three dimensional course of the helical guide vane 44. The flow openings 52 are covered by the helical guide vane 44 in a radial direction. The helical guide vane thus forms an outer radial side cover for the perforations 52 of the pre-separator sleeve 40. Of note, there is a common helical inlet or opening 70 formed in between the angled end section 44b of the helical guide vane 44 and the outside surface 42 of the pre-separator sleeve 40. In the embodiment shown, the gaseous fluid 12 is not only swirled when flowing from the inlet port 18 of the filter housing around the filter 28 but is further deflected in an axial direction before entering the helical inlet opening 70 and reaching the perforations 52 of the pre-separator sleeve 40. This allows for a further improvement of the pre-separating efficiency of the cyclone filter system 10 and filter 28, respectively.

What is claimed is:

1. A filter (28) for removing particulate matter from a gaseous fluid (12) comprising:
a filter element (30) with a filter media (32) which is arranged in a ring-shaped fashion around the longitudinal axis (34) thereof; and
a pre-separator sleeve (40) which seats on the filter element (30) and which has several perforations (52),
wherein on an outside surface (42) of the pre-separator sleeve (40), there is arranged at least one guide vane (44) which extends radially outwards from the pre-separator sleeve (40), wherein the guide vane (44) is wound around the pre-separator sleeve (40) in a helical fashion.

2. The filter according to claim 1, wherein the pre-separator sleeve (40) has a non-perforated first end portion (46) which serves as a baffle for the gaseous fluid (12).

3. The filter according to claim 2, wherein the non-perforated first end portion (46) of the pre-separator sleeve (40) has a circular flow locking means for preventing a circulating flow of the gaseous fluid (12) in a circumferential direction around the pre-separator sleeve (40).

4. The filter according to claim 3, wherein the flow-locking means is formed by an arcuate branch of the helical guide vane (44).

5. The filter according to claim 1, wherein the helical guide vane (44) in a longitudinal direction of the pre-separator sleeve (40), extends over a major portion of the total length (66) of the pre-separator sleeve (40).

6. The filter according to claim 1, wherein the helical guide vane (44), in the longitudinal direction, extends to or essentially to a reinforcement ring (60) of the pre-separator sleeve (40).

7. The filter according to claim 6, wherein the reinforcement ring (60) extends in a radial direction away from the pre separator sleeve (40) at a second end portion (48) thereof.

8. The filter according to claim 7, wherein the helical guide vane (44) has a base section (44a) extending away from the pre-separator sleeve (40) in a radial direction and an angled end section (44b) which is joined to the base section (44a).

9. The filter according to claim 8, wherein the end section (44b) is arranged parallel or essentially parallel to an outside surface (42) of the pre-separator sleeve (40).

10. The filter according to claim 8, wherein at least part of the perforations (52) of the pre-separator sleeve (40) are covered by the helical guide vane (44) in a radial direction.

11. The filter according to claim 1, wherein the helical guide vane (44) has a radial extension which is at least 10% of the outer diameter (54) of the pre-separator sleeve (40).

12. A cyclone filter system (10) for removing particulate matter from a gaseous fluid (12) comprising a filter housing (14) having a fluid inlet port (18) and a fluid outlet port (20); and a filter (28) according to claim 1 positioned inside the filter housing (14).

13. The cyclone filter system according to claim 12, wherein the fluid inlet port (18) is arranged laterally on a side wall of the filter housing (14) to allow for a radial or tangential flow of the gaseous fluid to the pre-separator sleeve (40).

14. The cyclone filter system according to claim 12, wherein the outlet port (20) of the filter housing (14) is arranged axially on an first end (22) of the filter housing (14) and which is preferably positioned adjacent to the fluid inlet port (18) thereof.

15. The cyclone filter system according to claim 12, wherein the filter housing (14) forms a dirt chamber (26) for particulate matter separated from the gaseous fluid (12) which, preferably, extends in a radial direction thereof.
